(19) United States
(12) Patent Application Publication
(10) Pub. No.: US 2024/0300753 A1
(43) Pub. Date: Sep. 12, 2024

(54) IMPROVED METHOD FOR LOADING A TARGET LOADING AID, AND WAREHOUSE AND PICKING SYSTEM THEREFOR

(71) Applicant: TGW Logistics Group GmbH, Marchtrenk (AT)

(72) Inventors: Timothy LINDLEY, Schwerte (DE); Gerald KETTLGRUBER, Linz (AT)

(73) Assignee: TGW Logistics Group GmbH, Marchtrenk (AT)

(21) Appl. No.: 18/575,722

(22) PCT Filed: Jun. 28, 2022
(86) PCT No.: PCT/AT2022/060225

§ 371 Date: Dec. 29, 2023

(30) Foreign Application Priority Data
Jun. 30, 2021 (AT) A 50543/2021

(51) Int. Cl. B65G 57/22

(52) U.S. Cl. CPC B65G 57/22

(57) ABSTRACT

The disclosure relates to a method for loading a target loading aid with articles at a loading station. A loading operation of the target loading aid with the articles is simulated with the help of loading properties and loading parameters. A loading pattern is generated based thereon, which is analysed on the using a target specification. That loading pattern that best fulfils the target specification is selected. Based thereon, a loading specification for the loading device is generated, and the loading operation is accordingly also carried out. A storage and picking system for carrying out the disclosed method is provided.

The invention relates to a method for loading a target loading aid with articles at a loading station with an automatic loading device. The invention further relates to a storage and picking system for carrying out the method. The storage and picking system comprises a storage zone, a loading station with an automatic loading device, a source conveying system and an order-processing computer.

This type of method and this type of storage and picking system are known in the prior art. The way in which the target loading aid is loaded is generally problematic in that it significantly influences the risk of damage to the articles contained therein during transport of the target loading aid. Heavy articles are typically arranged further down in a target loading aid, whereas light articles are more likely to be arranged further up, for example. If a customer orders heavy food cans as well as fragile wine glasses, the risk of breaking the glasses is reduced if these are arranged at the top of the target loading aid as indicated.

However, due to the large number of different types of articles that are handled in a modern storage and picking system, simple loading regulations do not necessarily lead to an advantageous way of packaging. In certain circumstances, it can be expedient to reverse the loading order for certain types of articles, for example if the customer orders a cushion and several jars of jam. The conventional procedure results in the jam, since it is heavier, being placed at the bottom of the target loading aid and the cushion at the top. The cushion would dampen the impact when the target loading aid is placed hard on a shelf and significantly reduce the risk of breaking the jars.

In addition, performance requirements for modern storage and picking systems inevitably lead to constantly increasing speeds and acceleration in the manipulation of the article. Here, too, simple motion regulations do not always lead to an optimal goal. The risk of breaking a wine glass whilst excessively accelerating is significantly higher than that of breaking a jam jar, for example.

Starting from the prior art, the end result requires a differentiated approach when loading a target loading aid.

A problem to be solved by the invention is therefore to indicate an improved method for loading a target loading aid and an improved storage and picking system for carrying out the method. In particular, a differentiated procedure for loading a target loading aid will be indicated.

The problem is solved by a method for loading a target loading aid with articles at a loading station with an automatic loading device comprising the following steps:
a) acquiring an order and determining the articles associated with the order using an order-processing computer
b) Providing loading properties that comprise properties of the loading device and article properties of the articles and are in particular recorded electronically in a database for a simulation unit
c) specifying loading parameters that comprise at least one parameter relating to the loading device and/or at least one parameter relating to the articles and/or at least one parameter relating to the target loading aid in the simulation unit
(d) simulating a loading operation of the target loading aid with articles using the simulation unit based on the loading properties and the loading parameters and generating a loading pattern with the simulation unit
e) repeating steps b) to d) with modified loading parameters
f) analysing the loading patterns generated on the basis of a target specification by means of the simulation unit
g) selecting the loading pattern that best fulfils the target specification and generating a loading regulation for the loading device, comprising the loading parameters that lead to the selected loading pattern by means of the simulation unit
h1) transporting the articles (with or without source loading aids) to the automatic loading device of the loading station, in particular by means of an automated source conveying system, and loading the target loading aid with the articles by means of the automatic loading device according to the loading regulation if at least one of the loading patterns fulfils the target specification. In particular, the articles can be transported to the automatic loading device of the loading station, with or without source loading aids, on an automated source conveying system.

In particular, loading the target loading aid with the articles can comprise delivering an article from the loading device and taking over the article on or in the target loading aid, for example a container, cardboard box, etc. Loading a target loading aid can comprise loading one or more articles.

In particular, an article can be moved from delivery (to the loading device) to transfer (on a target loading aid) by gravity alone, for example by falling, sliding and/or throwing. Only if it is expedient can a force component be applied to the articles in motion (and be “thrown”), for example to increase a movement speed or to change an orientation of the articles.

In particular, a “delivery” of articles must be distinguished from a “removal” of articles. When articles are “delivered”, motion of an article counter to the weight force, thus lifting an article, is not provided, while in the case of “removing”, motion of an article counter to the weight force, thus lifting an article, is provided. This applies in particular to delivery of the articles by falling or sliding. If an article is thrown, the article can be subjected to a force counter to the weight force in order to flatten a trajectory or to achieve an upward trajectory in the first portion.

The problem is further solved by a storage and picking system, in particular for carrying out the method according to one of the claims 1 to 15, comprising
a storage zone for providing articles
a loading station with an automatic loading device for loading target loading aids with articles according to a loading regulation (if at least one loading pattern fulfils a target specification)
a source conveying system for transporting the articles that connects the storage zone and the loading station
an order-processing computer for acquiring an order and determining the articles associated with the order
at least one database, in which loading properties comprising properties of the loading device and articles properties of the articles, can be provided and
a simulation unit, which is connected to the at least one database using data technology and which is configured for
processing loading properties, in particular electronically registered loading properties, comprising properties of the loading device and articles properties of the articles
processing a loading parameter specification comprising at least one parameter relating to the loading device and/or at least one parameter relating to the articles and/or at least one parameter relating to the target loading aid
simulating a loading operation of the target loading aid with articles based on the loading properties and the loading parameters
generating a loading pattern
repeating the aforementioned steps with modified loading parameters
analysing the loading patterns generated on the basis of the target specification
selecting that loading pattern that best fulfils the target specification and generating the loading regulations for the loading device, comprising the loading parameters that lead to the selected loading pattern.

The method and the storage and picking system presented help to achieve optimized loading of a target loading aid. For this purpose, a target specification is formulated and the loading operation is simulated before the actual loading of the target loading aid, wherein at least the loading parameters are varied. If a suitable loading pattern is found, i.e. one that particularly optimally fulfils the target specification, loading the target loading aid is carried out with the loading parameters found for real.

For loading the target loading aid, at least one article of the articles can be transferred to the target loading aid by falling, sliding and/or throwing, for example. This enables particularly high speeds when loading the target loading aid. However, there is a degree of uncertainty about the result of the loading operation since this is not strictly determinable due to falling, sliding and/or throwing. Applying the presented measures is particularly advantageous in this case as the uncertainty mentioned can be reduced by pre-simulation, thereby rendering the result of the loading operation more predictable and estimable.

The “loading pattern” indicates in particular how the articles are positioned in the target loading aid after the loading operation and in particular whether all the intended articles are in the target loading aid or whether some of the articles protrude from the target loading aid or have even fallen out of it. In other words, the loading pattern corresponds to a packing order in the target loading aid.

Preferably, the target specification is selected from a group comprising a fill level of the target loading aid, a state of the articles in the target loading aid, and/or a positioning of the articles in the target loading aid. The fill level can be specified, for example, as a percentage of the volume of the target loading aid, which is occupied by the articles located therein. In particular, the state of the articles in the target loading aid comprises an (elastic and/or plastic) permissible change in shape of the article, which it may have to a maximum extent in the target loading aid after reaching a resting state, in particular after a simulated fall or throw. The positioning of the articles is their position and orientation in the target loading aid. It can be provided that articles be arranged in the target loading aid for the customer in an appealing manner, for example. As described above, an article that has fallen out of the target loading aid would, for example, not have a position in the target loading aid and would therefore not fulfil a target specification relating to the positioning of the products. A target specification can also relate to a maximum tolerable risk of damage to the article during the loading operation and/or during further transport of the target loading aid. A loading operation with slightly modified loading properties can be simulated several times and the proportion of simulation runs in which damage to the article occurs can be determined, for example.

Accordingly, it is also advantageous if, in order to create the loading pattern,
the state of the articles is calculated by the simulation unit, the article having said state after reaching the resting state after simulated loading of the target loading aid with the articles
the fill level of the target loading aid is calculated by the simulation unit and/or
the positioning of the articles in the target loading aid is calculated by the simulation unit, the articles having said position after reaching the resting state after the simulated loading of the target loading aid with the articles.

Accordingly, it is also advantageous if step e) is repeated with modified loading properties. This means that the imprecisely determinable nature of the loading properties can be taken into account. Furthermore, the use of alternative loading devices or loading with alternative articles in step e) can lead to different properties of the loading device and articles properties of the articles.

In general, “loading properties” are fixed variables that are unchangeable or cannot be changed at short notice, which influence the loading operation. These comprise properties of the loading device and can relate to a geometry of the loading device, a friction coefficient of a chute, etc., for example. Article properties can relate to a geometry of an article, a weight of an article, a friction coefficient of an article, etc., for example:

“Loading parameters” are variables that can be changed (even at short notice) that influence the loading operation. A “parameter relating to the loading device” can be a loading speed, a dumping angle, a dumping height, a loading position, etc., for example. A “parameter relating to the articles” can be a loading sequence, an orientation of the articles before loading, etc, for example. A “parameter relating to the target loading aid” can be a shape, a dimension or a condition of the target loading aid, for example. The dumping angle of a source loading aid can be the angle during dumping of a hanging bag provided as a source loading aid, for example. The dumping angle may be indicated particularly as an angle between a bottom of the source loading aid and a horizontal plane.

Accordingly, it is also advantageous if:
the at least one parameter relating to the loading device is selected from a group comprising a construction of the loading device, a loading speed, a dumping angle of a source loading aid, a drop height of the article into the target loading aid and/or a loading position of the target loading aid and/or
the at least one parameter relating to the articles is selected from a group comprising a selection of articles of an order, a loading sequence and/or a positioning of the article when the articles are fed to the target loading aid and/or
the at least one parameter relating to the target loading aid is selected from a group comprising a target loading aid orientation, target loading aid position, target loading aid shape and/or target loading aid dimensioning.

The loading properties and/or loading parameters can be recorded using data technology and/or electronically with sensors. Loading parameters can also be formed by setpoint or manipulated variables for actuators. Loading properties and/or loading parameters can be stored in a database, however not all loading properties and loading parameters used for the simulation necessarily have to be stored in the database. One the one hand, it is particularly advantageous for some of the loading parameters, for example the parameters relating to the loading device, to be stored in the database (such as possible dumping angles, possible dumping heights, and the like), and, on the other hand, some of the loading parameters, in particular the loading sequence, to be generated or recorded during the process and to preferably not be already stored in the database. The database can be particularly configured to provide loading parameters comprising at least one parameter relating to the loading device and/or at least one parameter relating to the articles and/or at least one parameter relating to the target loading aid. The database is connected to the simulation unit using data technology such that the simulation unit can access the electronically recorded loading properties and/or loading parameters.

Articles properties relating to the articles can, in particular, originate from a supplier of the articles and can also be stored in the database. However, the articles properties can only be recorded electronically with sensors in the storage and picking system and stored in the database. As the database is connected to the simulation unit using data technology, the simulation unit can also access the electronically recorded articles properties.

The storage and picking system generally comprises one or more of the aforementioned databases, which can optionally be an integral component of the simulation unit.

At this point, it is noted that mentioning a “loading property” and a “loading parameter” within the scope of this disclosure may mean both a type or designation of this loading property/this loading parameter and its value. For example, the loading property for the weight of an article consists of its type or designation “weight” and its value, e.g. “5 kg”. Where reference is made to a variation in loading characteristics or loading parameters in the context of this disclosure, this may relate to a variation in type and/or a variation in value. For example, the loading property “width” can be incorporated into one simulation, and the loading property “weight” can be incorporated into another simulation. Similarly, the value for a weight “5 kg” can be incorporated into one simulation while the value “2 kg” can be incorporated into another simulation. Of course, a combined modification of the type and/or value is also possible. For example, the loading property “width”=“200 mm” can be incorporated into one simulation, and the loading property “weight”=“2 kg” into another simulation. It is ultimately also conceivable to interpret a loading property and/or a loading parameter as a combination of type or designation and the value thereof. For example, one loading property can be “weight 5 kg” and another loading property can be “weight 2 kg”

It is also advantageous if:
in step b), tolerance ranges for the loading properties, in particular for the articles properties, are additionally provided in the simulation unit and values for the loading properties are selected within the given tolerance ranges
in step d), the simulation is carried out for the selected values of the loading properties and
in step e), values for the loading properties are modified within the tolerance ranges and
the target specification in step f) comprises a robustness of the loading operation in relation to variations of the loading properties.

As mentioned, loading properties may not be precisely determinable. Loading properties are advantageously modified by variation within tolerance ranges, in particular randomly, meaning that the uncertainty mentioned can be taken into account in determining the loading properties. The “robustness of the loading operation” indicates the degree to which the result of the loading operation, in particular the loading pattern generated, depends on scattering loading properties.

It is also advantageous if:
in step c), tolerance ranges for the loading parameters are additionally provided in the simulation unit and values for the loading parameters are selected within the given tolerance ranges
in step d), the simulation is carried out for the selected values of the loading parameters and
in step e), values for the loading parameters are modified within the tolerance ranges and
the target specification in step f) comprises a robustness of the loading operation in relation to variations of the loading parameters.

Loading parameters may not precisely determinable either. For example, an actuating drive for setting a dumping angle may be subject to tolerances, resulting in uncertainty of the loading operation in this regard. Loading parameters can advantageously also be modified by variation within tolerance ranges, in particular again randomly, meaning that the mentioned uncertainty can be taken into account when determining loading parameters. In this case, the “robustness of the loading operation” indicates the degree to which the result of the loading operation depends on scattering loading parameters.

The simulation unit can comprise a “simulation module” and a separate “analysis module”. The analysis module can further have an output device for manual analysis or an analysis module for automatic analysis. If the simulation unit comprises a simulation module and an analysis module, the result is, in particular, a storage and picking system comprising
a storage zone for providing articles
a loading station with an automatic loading device for loading target loading aids with articles according to a loading regulation (if at least one loading pattern fulfils a target specification)
a source conveying system for transporting the articles that connects the storage zone and the loading station
an order-processing computer for acquiring an order and determining the articles associated with the order
at least one database, in which loading properties comprising properties of the loading device and articles properties of the articles, can be provided and
a simulation unit, which is connected to the at least one database using data technology and which has a simulation module and an analysis module, wherein the simulation module is configured to:
   processing loading properties, in particular electronically recorded loading properties, comprising properties of the loading device and articles properties of the articles by the simulation module
   processing a loading parameter specification comprising at least one parameter relating to the loading device and/or at least one parameter relating to the articles and/or at least one parameter relating to the target loading aid, by the simulation module
   simulating a loading operation of the target loading aid with articles based on the loading properties and the loading parameters by the simulation module
   generating a loading pattern by the simulation module
   repeating the aforementioned steps with modified loading parameters
   analysing the loading patterns generated on the basis of the target specification by the analysis module
   selecting that loading pattern that best fulfils the target specification, and generate the loading regulations for the loading device, comprising the loading parameters that lead to the selected loading pattern, by the analysis module.

The articles can be provided in the storage zone with or without loading aids and transported by means of the source conveying system with or without loading aids to the automatic loading device of the loading station. The storage zone can have a plurality of stationary storage racks and at least one automatically operated storage and retrieval device for storing the articles in the storage racks and/or retrieving the articles from the storage racks, for example. The storage racks can be configured for the suspended and/or horizontal (lying) provision of articles for this purpose.

Destination loading aids can be loaded with articles at the automatic loading device.

If the articles are transported with loading aids, these correspond to “source loading aids”. Accordingly, loading a target loading aid may also include unloading the source loading aid. The target loading aid can be loaded by transferring the article from the source loading aid to the target loading aid in this case. A source loading aid can be a container, a tray, a cardboard box or also a hanging bag, for example. The articles can be provided with the source loading aids in the storage racks.

In particular, a hanging bag according to patent application WO 2019/195871 A1 or WO 2020/150762 A1 can be configured and used in the manner described therein for the method disclosed here and the storage and picking system disclosed here. According to this embodiment, a target loading aid is loaded by unloading a hanging bag (source loading aid). The hanging bag can be unloaded using an unloading station described in WO 2019/195871 A1.

In particular, a container with a closable bottom opening can be configured according to patent application WO 2012/024714 A2 and used in the manner described therein for the method disclosed here and the storage and picking system disclosed here. According to this embodiment, a target loading aid is loaded by unloading a container (source loading aid). The container can be unloaded using a transfer station described in WO 2012/024714 A2.

A “target loading aid” can be a container, a cardboard box, a shipping package (shipping box, shipping bag), etc., for example.

An “automated source conveying” can comprise a stationary conveying system and/or a mobile conveying system. In the same way, an “automated target conveying” can comprise a stationary conveying system and/or a mobile conveying system. An “automated source conveying system” can also be configured for horizontal (lying) or suspended transport of articles. By analogy, an “automated target conveying system” can also be configured for horizontal (lying) or suspended transport of articles.

A stationary conveying system for horizontally transporting articles can be configured, for example, as a ground-based conveying system, for example as a roller conveying system or as a belt conveying system.

A stationary conveying system for suspended transport of articles can preferably be configured as a suspended conveying system, which can comprise hanging bags for receiving the article. In this case, the article can be transported on the suspended conveying system by means of a transport carrier (e.g. with a coat hook) and in particular also in a hanging bag. Preferably, exactly one article is transported with a transport carrier or in the hanging bag. However, it is also possible for more than one article to be transported at the same time with a transport carrier or with the hanging bag. If multiple articles are transported simultaneously with a transport carrier or a hanging bag, these are predominantly articles of the same article type.

A mobile conveying system can comprise an automated conveyor vehicle, for example an automated guided vehicle (AGV), or an autonomous mobile robot (AMR), for example. A mobile conveying system for suspended transport of articles can also comprise suspended conveying systems arranged on automated conveyor vehicles, for example.

Loading the target loading aid may form the picking operation or may be part of a picking operation. In this context, the loading station can also be understood as a “picking station” and referred to as such. In particular, the target loading aid can also assume the role of a shipping loading aid, which is subsequently transported away from the storage and picking system and taken to a recipient.

Further advantageous embodiments and advancements of the invention can be found in the subclaims as well as a combination of the description with the figures.

It is advantageous for the method presented to additionally include the step
h2) transporting the articles to a further loading device of the loading station and loading the target loading aid with the articles by an operating member, and
   evaluating in step f) comprises checking whether at least one of the loading patterns fulfils the target specification and
   the steps g) and h1) are carried out if at least one of the loading patterns fulfils the target specification or
   step h2), omitting step g), is carried out if none of the loading patterns fulfils the target specification.

As a result, articles for which no suitable loading pattern can be found during the simulation of the loading operation can also be handled in the storage and picking system.

The articles can be provided in the storage zone with or without loading aids and transported by means of the source conveying system with or without loading aids to the automatic loading device of the loading station.

An “operating member” may be, for example, an operator, a humanoid robot, or a robot with a gripper arm that is able to select a placement position in the target loading aid itself, for example, using an artificial intelligence algorithm. It is also advantageous for the further loading device to be a manual loading device and the operating member to be an operator. As a result, articles for which no suitable loading pattern can be found during the simulation of the loading operation can also be handled particularly flexibly in this way.

The target loading aid can be loaded with articles by the operator at the manual loading device. When the articles are transported in source loading aids, loading the target loading aid can include removing the articles from source loading aids and placing the articles in the target loading aid. In other words, the articles are transferred from source loading aids to the target loading aid by the operator at the manual loading device.

The manual loading device can comprise an input and/or output device. The input and/or output device preferably has an output means for outputting loading instructions, for example a screen on which the operator receives loading instructions for loading the target loading aid. Furthermore, the input and/or output device can have an input means for inputting an acknowledgement command, for example a keyboard or a button that the operator can use to acknowledge (confirm) loading of the target loading aid has taken place. The input means and output means can be provided by a touch display, for example.

It is also advantageous for step f) to be carried out before step e), wherein
evaluating in step f) comprises checking whether the generated loading pattern fulfils the target specification and
after step f), step e) is carried out if the determined loading pattern does not fulfil the target specification or
after step f), step g) is carried out, omitting step e), if the determined loading pattern fulfils the target specification.

In this embodiment, no further simulation run is carried out as soon as a loading pattern fulfils the target specification. As a result, this embodiment leads particularly quickly to a result.

It is also advantageous for an analysis quantity to be defined that comprises any number of orders, wherein steps a) to g) are carried out for all orders of the analysis quantity and wherein the method comprises the following steps between steps f) and g):
i) generating a first order quantity, which comprises all orders for which at least one loading pattern has been created that fulfils the target specification
ii) generating a second order quantity, which comprises all orders for which at least one loading pattern has been generated that fulfils the target specification.

In this way, a large number of orders can be simulated in advance, wherein the orders are subsequently divided into automatically processable orders (first order quantity) and non-automatically processable orders (second order quantity) and further processed accordingly. The second order quantity is carried out in particular by an operating member, specifically by an operator.

It is favourable for loading the target loading aid with the articles in step h1) to detected by a camera and a model for the loading simulation to be adaptively adjusted to real loading in the simulation unit in accordance with the loading detected by the camera. In particular, it is advantageous for the loading properties and/or the loading parameters to be adjusted according to the detection. As a result, incorrect assumptions regarding the loading simulation model and, in particular, incorrect assumptions regarding the loading properties and/or the loading parameters can be corrected and adjusted in line with reality. Over the course of time, the simulation thus corresponds evermore to real conditions.

It is also advantageous for loading the target loading aid to be virtualised with the help of virtual twins of the loading device, the target loading aid and/or the articles, and for the loading properties and/or the loading parameters of the virtual loading device, the virtual target loading aid and/or the virtual articles to be adjusted in accordance with the detection of the loading by the camera. Virtual twins are particularly suitable for implementing simulations or for observing and evaluating these. Human or artificial intelligence can help to achieve an optimised result, i.e. optimized fulfilment of the target specification, in as few simulation runs as possible.

The figures below elaborate on the invention to offer better understanding thereof. The figures show in greatly simplified, schematic depiction:

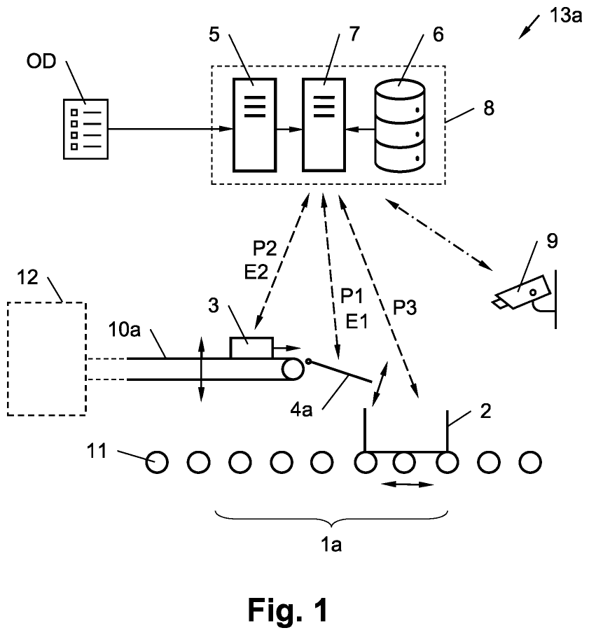

FIG. 1 a schematic representation of a first exemplary loading station in a storage and picking system;

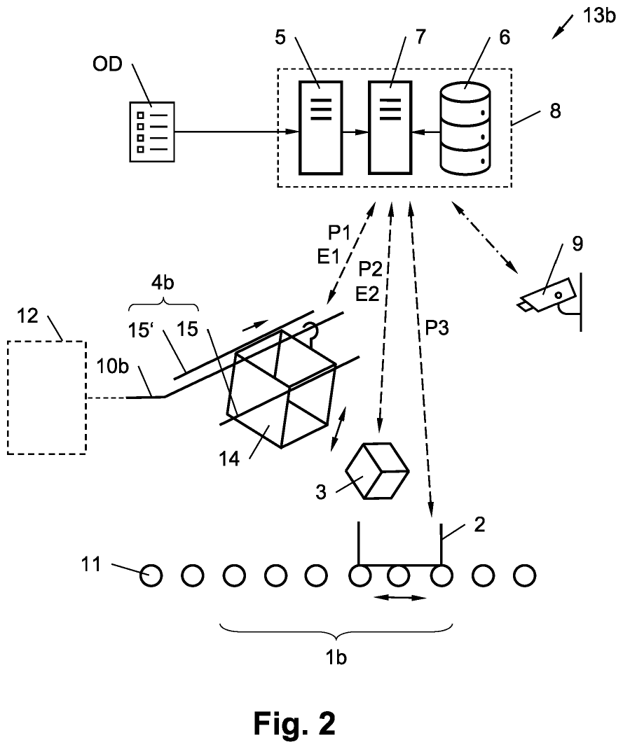

FIG. 2 a schematic representation of a second exemplary loading station in a storage and picking system;

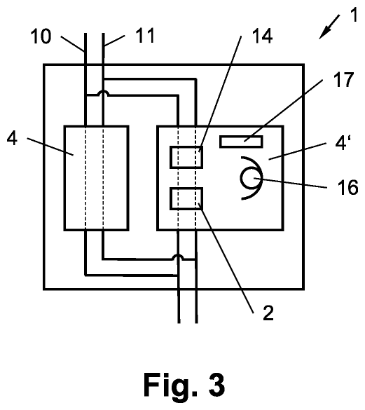

FIG. 3 a schematic representation of a further exemplary loading station with an automatic loading device and a further loading device;

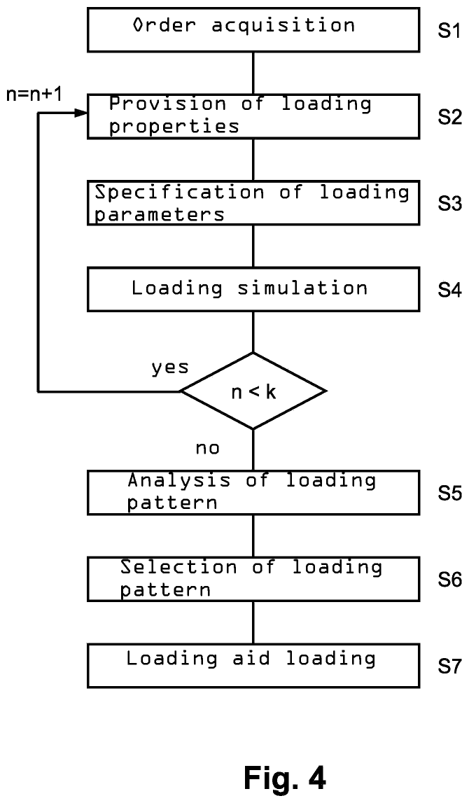

FIG. 4 a flowchart relating to the central steps of the method presented;

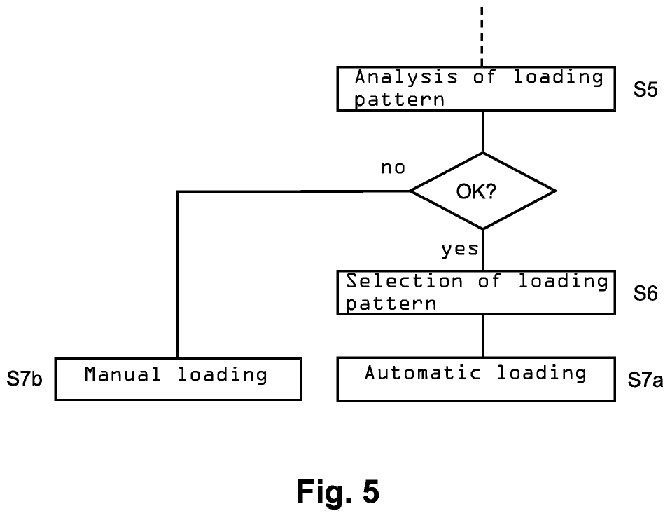

FIG. 5 a flowchart for an embodiment, in which a portion of the articles is loaded automatically and another portion of the articles manually into the target loading aid; and

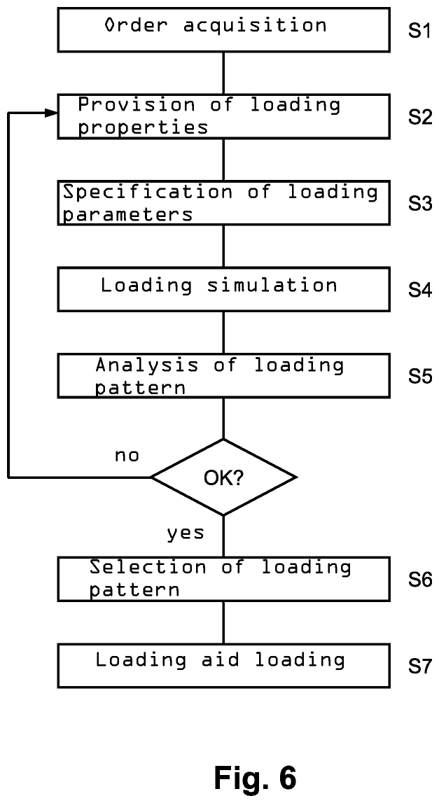

FIG. 6 a flowchart for an embodiment of a shortened simulation method that is aborted when a target specification is first fulfilled.

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. also refer to the figure directly described and shown, and these indications of position can be applied in the same way to the new position should the position change.

FIG. 1 shows a first example of a loading station 1a for loading target loading aids 2 with articles 3 according to a loading specification. The loading station 1a comprises an automatic loading device 4a for this purpose, which is configured as a chute in this example, whose inclination is adjustable as symbolised by an arrow in FIG. 1. A “target loading aid” 2 can be a container, a cardboard box, a shipping package (shipping box, shipping bag), etc., for example.

In addition, FIG. 1 shows an order-processing computer 5, a database 6 and a simulation unit 7, which together form or are part of a computer system 8. The order-processing computer 5 is configured to acquire an order OD and determine the articles 3 associated with the order OD. Loading properties are provided in the database 6 and the simulation unit 7 is used to simulate a loading operation of the target loading aid 2 with the article 3. The simulation unit 7 can comprise a simulation module and a separate analysis module for this purpose. The analysis module can further have an output device for manual analysis or an analysis module for automatic analysis. Furthermore, the simulation unit 7 can comprise the database 6.

In addition, FIG. 1 also shows an optional camera 9 connected to the computer system 8 and in particular to the simulation unit 7 for detecting the real loading operation of the target loading aid 2 with the article 3.

FIG. 1 further shows a source conveying system 10a and a target conveying system 11. The source conveying system 10a is connected to an optional storage zone 12. The source conveying system 10a is provided for transporting the articles 3 from the storage zone 12 to the loading station 1a, and the target conveying system 11 is configured for transporting the target loading aid 2 to the loading station 1a and for transporting the target loading aid 2 away from the loading station 1a.

The objects shown in FIG. 1 are part of a storage and picking system 13a or form it.

In the example shown in FIG. 1, the source conveying system 10a and the target conveying system 11 is configured as a stationary conveying system. Specifically, the source conveying system 10a comprises an exemplary conveyor belt and the target conveying system 11 an exemplary roller conveyor. However, other embodiments are equally possible. It would further be conceivable for the source conveying system 10a and/or the target conveying system 11 to be configured as a mobile conveying system. This can have “automated guided vehicles” (AGV for short) or “autonomous mobile robots” (AMR for short), for example.

The source conveying system 10a and the target conveying system 11 are further configured for the horizontal (lying) articles 3. Specifically, the article 3 is transported on the source conveying system 10a without a loading aid, whereas the article 3 is transported on the target conveyor system 11 with the help of the target loading aid 2. However, it would also be conceivable for the article 3 to be transported on the source conveying system 10a with a source loading aid (see also FIG. 2). A source loading aid can generally also be a container, a tray or a cardboard box. A source loading aid can also be configured to discharge an article 3 with a closable bottom opening according to patent application WO 2012/024714 A2 and used in the manner described therein for the method disclosed here and the storage and picking system 13a disclosed here.

The storage zone 12 can have a plurality of stationary storage racks and at least one automatically operated storage and retrieval device for storing the articles 3 in the storage racks and/or retrieving the articles 3 from the storage racks. A storage rack and storage retrieval device of this type are known in the prior art and will therefore not be described in more detail.

In this example, the source conveying system 10a is configured to be height adjustable and can also be configured to be adjustable in terms of the conveying speed (see the arrows in FIG. 1). Thus, the loading operation is also influenced by the source conveying system 10a. Consequently, in this case, that is to say generally when it influences the loading operation, the source conveying system 10a can be regarded as part of the loading station 1a or as part of the loading device 4a.

In the example shown in FIG. 1, the article 3 is delivered into the target loading aid 2 by sliding and falling. This is not the only conceivable possibility. Rather, it would also be conceivable for the chute 4a to extend to the bottom of the target loading aid 2 and for the article 3 therefore not to fall into the target loading aid 2 but only to slide or slip. It would also be conceivable for the article 3 to be thrown or placed into the target loading aid 2, for example with the aid of an articulated-arm robot or gantry robot. It would also be possible to do away with the chute 4a and discharge the article 3 directly from the source conveying system 10a into the target loading aid 2.

FIG. 2 shows an alternative exemplary embodiment of a loading station 1b or a storage and picking system 13b, which is very similar to the loading station 1a shown in FIG. 1 or the storage and picking system 13a shown in FIG. 1. In contrast, the source conveying system 10b is configured in this example as a suspended conveying system and is provided for the suspended transport of the articles 3 in source loading aids 14, which are configured as hanging bags. The hanging bag 14 is transported on a transport carrier of the source conveying system 10b from the storage zone 12 to the loading station 1b, where it is automatically opened with the help of the guideways 15, 15′ tilted, in particular, to a dumping angle. The guideway 15 acts on the front part of the hanging bag 14 and presses it downwards, whereas the guideway 15′ acts on the rear part of the hanging bag 14 and presses it upwards. Accordingly, the guideways 15, 15′ form the loading device 4b or are part of it in this example. To better illustrate the process of opening and tilting the hanging bag 14, the hanging bag 14, the source conveying system 10b, the loading device 4b and the article 3 are shown in oblique view in the region of the loading station 1b. In this case, the hanging bag 14 is shown in a dumping position in which the article 3 can be automatically discharged into the target loading aid 2, the hanging bag 14 being inclined at the dumping angle.

In the example shown in FIG. 2, the article 3 is also discharged into the target loading aid 2 by sliding and falling. However, it would also be conceivable for the article 3 to be discharged from the hanging bag 14 onto a chute (cf. FIG. 1) that leads to the bottom of the target loading aid 2, for example. In general, it would also be conceivable to discharge the article 3 into the target loading aid 2 using a robot with a (suction) gripper, which removes the article 3 from the source conveying system 10a, 10b and places it in the target loading aid 2.

In particular, a hanging bag 14 according to patent application WO 2019/195871 A1 or WO 2020/150762 A1 can be configured and used in the manner described therein for the method disclosed here and the storage and picking system 13b disclosed here. The hanging bag 14 can be unloaded with an unloading station described in WO 2019/195871 A1, which is similarly constructed to the schematically shown loading device 4b of FIG. 2.

As shown in FIG. 3 a loading station 1 can have a further loading device 4′ in addition to the (automatic) loading device 4, the former being configured for manually loading the target loading aids 2 by an operator 16, i.e. as a manual loading device 4′.

Therefore, the target loading aid 2 can be loaded with articles 3 by the operator 16 at the further loading device 4′. When the articles 3 are transported in source loading aids 14, the articles 3 can be transferred from the source loading aids 14 to the target loading aid 2 at the further (manual) loading device 4′ by the operator 16 as shown in FIG. 3.

The further loading device 4′ can comprise an input and/or output device 17. The input and/or output device 17 preferably has an output means for outputting loading instructions, for example a screen on which the operator 16 receives loading instructions for loading the target loading aid 14. Furthermore, the input and/or output device 17 can have an input means for inputting an acknowledgement command, for example a keyboard or a button that the operator 16 can use to acknowledge (confirm) that loading of the target loading aid 14 has taken place.

The source conveying system 10 and the target conveying system 11 can be configured as described in the context of FIG. 1 and FIG. 2 and can be connected to both the loading device 4 and the further loading device 4′ using conveying technology, as shown in FIG. 3.

The loading station 1, 1a, 1b can be used in particular for picking articles 3. Accordingly, the loading station 1, 1a, 1b can also be referred to as a “picking station” in this case.

The sequence of the method presented for loading a target loading aid 2 in general is as follows, the method being explained by way of example with reference to the arrangements shown in FIGS. 1 and 2 and to the flowchart shown in FIG. 4.

The method presented comprises the following steps:
a) acquiring S1 an order OD and determining the articles 3 associated with the order OD by the order-processing computer 5
b) providing S2 loading properties, in particular electronically recorded loading properties E1, comprising properties of the loading device 4, 4a, 4b and articles properties E2 of the articles 3, in the database 6 for the simulation unit 7
c) specifying S3 loading parameters, which comprise at least one parameter P1 relating to the loading device 4, 4a, 4b and/or at least one parameter P2 relating to the articles 3 and/or at least one parameter P3 relating to the target loading aid 2, in the simulation unit 7
d) simulating S4 a loading operation of the target loading aid 2 with articles 3 using the simulation unit 7 based on the loading properties E1, E2 and the loading parameters P1 . . . . P3 and generating a loading pattern with the simulation unit 7
e) repeating steps b) to d) with modified loading parameters P1 . . . . P3
f) analysing S5 the loading patterns generated on the basis of a target specification by means of the simulation unit 7
g) selecting S6 the loading pattern that best fulfils the target specification and generating a loading regulation for the loading device 4, 4a, 4b, comprising the loading parameters P1 . . . . P3 that lead to the selected loading pattern by means of the simulation unit 7
h1) transporting S7 the articles 3 to the automatic loading device 4, 4a, 4b, of the loading station 1, 1a, 1b, in particular by means of an automated source conveying system 10, 10a, 10b, and loading the target loading aid 2 with the articles 3 by means of the automatic loading device 4, 4a, 4b, according to the loading regulation if at least one of the loading patterns fulfils the target specification.

For example,
the at least one parameter P1 relating to the loading device 4, 4a, 4b can be selected from a group comprising a construction of the loading device 4, 4a, 4b, a loading speed, a dumping angle of a source loading aid 14, a drop height of the article 3 into the target loading aid 2 and/or a loading position of the target loading aid 2 and/or
the at least one parameter P2 relating to the articles 3 can be selected from a group comprising a selection of articles 3 of an order OD, a loading sequence and/or a positioning of the article 3 when the articles 3 are fed to the target loading aid 2 and/or
the at least one parameter P3 relating to the target loading aid 2 can be selected from a group comprising a target loading aid orientation, target loading aid position, target loading aid shape and/or target loading aid dimensioning.

In order to generate the loading pattern, the simulation unit 7 can calculate, for example:

the state of the articles 3, the article 3 having said state after reaching the resting state after simulated loading of the target loading aid 2 with the articles 3
the fill level of the target loading aid 2 and/or
the positioning of the articles 3 in the target loading aid 2, the articles 3 having said position after reaching the resting state after the simulated loading of the target loading aid 2 with the articles 3.

In particular, the state of the articles 3 in the target loading aid 2 comprises an (elastic and/or plastic) change in shape of the article 3, which it may have to a maximum extent in the target loading aid 2 after reaching a resting state (in particular after a simulated fall or throw). The loading pattern indicates, in particular, the positioning of the articles 3 in the target loading aid 2 after the loading operation and, in particular, whether all the intended articles 3 are in the target loading aid 2 or whether some of the articles 3 protrude from the target loading aid 2 or have even fallen out of it. In other words, the loading pattern corresponds to a packing order in the target loading aid 2.

From the large number of loading patterns obtained in several simulation runs, the one that best fulfils a target specification is selected. Subsequently, a corresponding loading regulation is created, which serves as the basis for the real loading operation of the target loading aid 2.

Preferably, the target specification is selected from a group comprising a fill level of the target loading aid 2, a state of the articles 3 in the target loading aid 2, and/or a positioning of the articles 3 in the target loading aid 2. In particular, the target specification can also concern a permissible (elastic and/or plastic) change in shape of the article 3, which it may have to a maximum extent in the target loading aid 2 after reaching a resting state (in particular after a simulated fall or throw). The fill level can be specified, for example, as a percentage of the volume of the target loading aid 2, which is occupied by the articles 3 located therein. The positioning of the articles 3 is their position and orientation in the target loading aid 2. It can be provided that articles 3 are arranged in the target loading aid 2 for the customer in an appealing manner, for example. A target specification can also relate to a maximum tolerable risk of damage to the article 3 during the loading operation and/or during further transport of the target loading aid 2. A loading operation with slightly modified loading properties E1, E2, can be simulated several times and the proportion of simulation runs in which damage to the article 3 occurs can be determined, for example.

The loading properties E1, E2, and/or loading parameters P1 . . . . P3 can be stored in the database 6 and read from there by the simulation unit 7. However, the loading properties E1, E2, and/or loading parameters P1 . . . . P3 can also be recorded using data technology and/or electronic sensors. The dimensions of the target loading aid 2 could be detected with a sensor, for example. These would then not need to be stored in the database 6. It is also conceivable for the loading properties E1, E2 and/or loading parameters P1 . . . . P3 to be determined by reading an identification mark, such as an RFID tag, a barcode, a two-dimensional code, such as a quick-response code or the like, which is arranged on the article 3, the destination loading aid 2 or the source loading aid 14, for example. Loading parameters P1, P3 can also be formed by manipulating or setpoint variables for actuators, for example by a manipulating or setpoint variable for the actuating drive of the chute 4a or by a manipulating or setpoint variable for a drive roller of the target conveying system 11. It is also conceivable that some of the loading parameters P1 . . . . P3 are generated for the simulation, such as a loading sequence for the target loading aid 2.

The optional camera 9 is used to detect loading of the target loading aid 2 with the articles 3 in step h1). As a result, a model for the loading operation simulation can be adaptively adjusted to real loading in accordance with the loading detected by the camera 9. In particular, the loading properties E1, E2 and/or the loading parameters P1 . . . . P3 are adjusted according to the detection. As a result, incorrect assumptions regarding the loading operation simulation model and, in particular, incorrect assumptions regarding the loading properties E1, E2 and/or the loading parameters P1 . . . . P3 can be corrected and adjusted in line with reality. Over the course of time, the simulation thus corresponds evermore to real conditions.

It is also generally advantageous for loading the target loading aid 2 to be virtualised with the help of virtual twins of the loading device 4, 4a, 4b, the target loading aid 2 and/or the articles 3, and for the loading properties E1, E2 and/or the loading parameters P1 . . . . P3 of the virtual loading device 4, 4a, 4b, the virtual target loading aid 2 and/or the virtual articles 3 to be adjusted in accordance with the detection of the loading by the camera 9. Virtual twins are particularly suitable for implementing simulations or for observing and evaluating these. Human or artificial intelligence can help to achieve an optimised result, i.e. optimized fulfilment of the target specification, in as few simulation runs as possible.

It is also generally advantageous for step e) to be repeated with modified loading properties E1, E2. This means that the imprecisely determinable nature of the loading properties E1, E2 can be taken into account. Furthermore, the use of alternative loading devices 4, 4a, 4b or loading the target loading aid 2 with alternative articles 3 in step e) can lead to different properties E1 of the loading device 4, 4a, 4b and articles properties E2 of the articles 3.

In general, it is also advantageous if
in step b), tolerance ranges for the loading properties E1, E2, in particular for the articles properties, are additionally provided in the simulation unit 7 and values for the loading properties E1, E2 are selected within the given tolerance ranges
in step d), the simulation is carried out for the selected values of the loading properties E1, E2 and
in step e), values for the loading properties E1, E2 are modified within the tolerance ranges and
the target specification in step f) comprises a robustness of the loading operation in relation to variations of the loading properties E1, E2.

As mentioned, loading properties E1, E2 may not be precisely determinable. Loading properties E1, E2 are advantageously modified by variation within tolerance ranges, in particular randomly, meaning that the uncertainty mentioned can be taken into account in determining the loading properties E1, E2.

In addition, it is generally advantageous if
in step c), tolerance ranges for the loading parameters P1 . . . . P3 are additionally provided in the simulation unit 7 and values for the loading parameters P1 . . . . P3 are selected within the given tolerance ranges
in step d), the simulation is carried out for the selected values of the loading parameters P1 . . . . P3 and
in step e), values for the loading parameters P1 . . . . P3 are modified within the tolerance ranges and
the target specification in step f) comprises a robustness of the loading operation in relation to variations of the loading parameters P1 . . . . P3.

Loading parameters P1 . . . . P3 may not precisely determinable either. For example, an actuating drive for setting a chute 4a may be subject to tolerances, resulting in uncertainty of the loading operation in this regard. Loading parameters P1 . . . . P3 can advantageously also be changed by variation within tolerance ranges, in particular again randomly, meaning that the mentioned uncertainty can be taken into account when determining loading parameters P1 . . . . P3.

FIG. 5 shows an embodiment, in which the method presented additionally comprises the step
h2) transporting the articles 3 to the further loading device 4′ of the loading station 1, 1a, 1b and loading the target loading aid 2 with the articles 3 by an operating member, in particular the operator 16, wherein
   evaluating in step f) comprises checking whether at least one of the loading patterns fulfils the target specification and
   the steps g) and h1) are carried out if at least one of the loading patterns fulfils the target specification (see step S7a) or
   step h2) is carried out, omitting step g), if none of the loading patterns fulfils the target specification (see step S7b).

As a result, articles 3, for which no suitable loading pattern can be found during the simulation of the loading operation, can also be handled in the storage and picking system 13a, 13b.

The operating member may be an operator 16. An “operating member” may be, for example, an operator, a humanoid robot, or a robot with a gripper arm that is able to select a placement position in the target loading aid 2 itself using an artificial intelligence algorithm, for example. The further loading device 4′ can particularly be a manual loading device 4′.

In a further advantageous variant, an analysis quantity is defined that comprises any number of orders OD, wherein steps a) to g) are carried out for all orders OD of the analysis quantity and wherein the method comprises the following steps between steps f) and g):
i) generating a first order quantity, which comprises all orders OD for which at least one loading pattern has been generated that fulfils the target specification
ii) generating a second order quantity, which comprises all orders OD for which at least one loading pattern has been generated that fulfils the target specification.

In this way, a large number of orders OD can be simulated in advance, wherein the orders OD are subsequently divided into automatically processable orders OD (first order quantity) and non-automatically processable orders OD (second order quantity) and further processed accordingly. The second order quantity is carried out in particular by an operating member (cf. FIG. 5).

FIG. 6 shows a further embodiment, in which step f) is carried out before step e), wherein
evaluating in step f) comprises checking whether the generated loading pattern fulfils the target specification and
after step f), step e) is carried out if the determined loading pattern does not fulfil the target specification or
after step f), step g) is carried out, omitting step e), if the determined loading pattern fulfils the target specification.

In this embodiment, no further simulation run is carried out as soon as a loading pattern fulfils the target specification. As a result, this embodiment leads particularly quickly to a result.

Finally, it is further stated that the scope of protection is determined by the claims. However, the description and the drawings are to be referenced for the interpretation of the claims. Individual features or combinations of features from the various exemplary embodiments shown and described can represent independent inventive solutions in themselves. The problem to be solved, upon which the independent, inventive solutions are based, can be derived from the description.

It is also particularly stated that the devices shown can, in reality, also comprise more or even fewer components than those shown. In some cases, the devices shown or their components have not been shown to scale and/or enlarged and/or shrunk.

### LIST OF REFERENCE NUMERALS

1, 1a, 1b Loading station
2 Target loading aid
3 Article
4, 4a, 4b (Automatic) loading device
4′ (Manual) loading device
5 Order-processing computer
6 Database
7 Simulation unit
8 Computer system
9 Camera
10, 10a, 10b Source conveying system
11 Target conveying system
12 Storage zone
13a, 13b Storage and picking system
14 Source loading aid (hanging bag)
15, 15′ Guideway
16 Operator
17 Input and/or output device
OD Order
E1, E2 Loading property
P1 . . . . P3 Loading parameter
S1 . . . . S7 Method step

1. A method for loading a target loading aid with articles at a loading station with an automatic loading device, comprising the steps:
a) acquiring (S1) an order (OD) and determining the articles associated with the order (OD) using an order-processing computer;
b) providing (S2) loading properties comprising properties (E1) of the loading device and articles properties (E2) of the articles in a database for a simulation unit;
c) specifying (S3) loading parameters comprising at least one parameter (P1) relating to the loading device and/or at least one parameter (P2) relating to the articles and/or at least one parameter (P3) relating to the target loading aid in the simulation unit;
d) simulating (S4) a loading operation of the target loading aid with articles using the simulation unit based on the loading properties (E1, E2) and the loading parameters (P1 . . . P3) and generating a loading pattern with the simulation unit;
e) repeating steps b) to d) with modified loading parameters (P1 . . . P3);
f) analyzing (S5) the loading patterns generated on the basis of a target specification by means of the simulation unit;
g) selecting (S6) that loading pattern that best fulfils the target specification and generating the loading regulation for the loading device comprising the loading parameters (P1 . . . P3) that lead to the selected loading pattern by means of the simulation unit;
h1) transporting (S7) the articles to the automatic loading device of the loading station and loading the target loading aid with the articles by means of the automatic loading device according to the loading regulation if at least one of the loading patterns fulfils the target specification.

2. The method according to claim 1, wherein the method further comprises:
transporting (h1) the articles to a further loading device of the loading station and loading the target loading aid with the articles by an operating member, and
evaluating in step f) comprises checking whether at least one of the loading patterns fulfils the target specification, and
the steps g) and h1) are carried out if at least one of the loading patterns fulfils the target specification, or
step h2), omitting step g), is carried out if none of the loading patterns fulfils the target specification.

3. The method according to claim 2, wherein the further loading device is a manual loading device and the operating member is an operator.

4. The method according to claim 1, wherein for loading the target loading aid, at least one article of the articles is transferred to the target loading aid by falling, sliding and/or throwing.

5. The method according to claim 1, wherein the step f) is carried out before the step e), wherein;
evaluating in step f) comprises checking whether the generated loading pattern fulfils the target specification, or
after step f), step e) is carried out if the determined loading pattern does not fulfil the target specification, or
after step f), step g) is carried out, omitting step e), if the determined loading pattern fulfils the target specification.

6. The method according to claim 1, wherein an analysis quantity is defined that comprises any number of orders (OD), wherein steps a) to g) are carried out for all orders (OD) of the analysis quantity, wherein the method comprises the following steps between steps f) and g):
i) generating a first order quantity, which comprises all orders (OD) for which at least one loading pattern has been generated that fulfils the target specification,
ii) generating a second order quantity, which comprises all orders (OD) for which at least one loading pattern has been generated that fulfils the target specification.

7. The method according to claim 1, wherein:
the at least one parameter (P1) relating to the loading device is selected from a group comprising a construction of the loading device, a loading speed, a dumping angle of a source loading aid, a drop height of the article into the target loading aid and/or a loading position of the target loading aid, and/or
the at least one parameter (P2) relating to the articles is selected from a group comprising a selection of articles of an order (OD), a loading sequence and/or a positioning of the article when the articles are fed to the target loading aid, and/or
the at least one parameter (P3) relating to the target loading aid is selected from a group comprising a target loading aid orientation, target loading aid position, target loading aid shape and/or target loading aid dimensioning.

8. The method according to claim 1, wherein the target specification is selected from a group comprising a fill level of the target loading aid, a state of the articles in the target loading aid and/or a positioning of the articles in the target loading aid.

9. The method according to claim 8, wherein to generate the loading pattern,
the state of the articles is calculated by the simulation unit, the article having said state after reaching the resting state after simulated loading of the target loading aid with the articles,
the fill level of the target loading aid is calculated by the simulation unit, and/or
the positioning of the articles in the target loading aid is calculated by the simulation unit, the articles having said position after reaching the resting state after the simulated loading of the target loading aid with the articles.

10. The method according to claim 1, wherein the step e) is repeated with modified loading properties (E1, E2).

11. The method according to claim 1, wherein:
in step b), tolerance ranges for the loading properties (E1, E2) are additionally provided in the simulation unit and values for the loading properties (E1, E2) are selected within the given tolerance ranges,
in step d), the simulation is carried out for the selected values of the loading properties (E1, E2),
in step e), values for the loading properties (E1, E2) are modified within the tolerance ranges, and
the target specification in step f) comprises a robustness of the loading process in relation to variations of the loading properties (E1, E2).

12. The method according to claim 1, wherein:
in step c), tolerance ranges for the loading parameters (P1 . . . P3) are additionally provided in the simulation unit and values for the loading parameters (P1 . . . P3) are selected within the given tolerance ranges,
in step d), the simulation is carried out for the selected values of the loading parameters (P1 . . . P3),
in step e), values for the loading parameters (P1 . . . P3) are modified within the tolerance ranges, and
the target specification in step f) comprises a robustness of the loading process in relation to variations of the loading parameters (P1 . . . P3).

13. The method according to claim 1, wherein loading the target loading aid with the articles in step h1) is detected by a camera and a model for simulating loading in the simulation unit is adaptively adjusted in accordance with the detection of the camera to real loading.

14. The method according claim 13, wherein the loading properties (E1, E2) and/or the loading parameters (P1 . . . P3) are adjusted according to the detection.

15. The method according to claim 13, wherein loading the target loading aid is virtualized with the help of virtual twins of the loading device, the target loading aid and/or the articles, and the loading properties (E1, E2) and/or the loading parameters (P1 . . . P3) of the virtual loading device, the virtual target loading aid and/or the virtual articles are adjusted in accordance with the detection of loading by the camera.

16. A storage and picking system (13a . . . 13d) comprising:
a storage zone for providing articles;
a loading station with an automatic loading device for loading target loading aids with articles according to a loading regulation;
a source conveying system for transporting the articles that connects the storage zone and the loading station;
an order-processing computer for acquiring (S1) an order (OD) and determining the articles associated with the order (OD);
at least one database, in which loading properties comprising properties (E1) of the loading device and articles properties (E2) of the articles, can be provided; and
a simulation unit, which is connected to the at least one database using data technology and which is configured for:
processing (S2) loading properties, comprising properties (E1) of the loading device and articles properties (E2) of the articles,
processing a loading parameter specification (S3) comprising at least one parameter (P1) relating to the loading device and/or at least one parameter (P2) relating to the articles and/or at least one parameter (P3) relating to the target loading aid,
simulating (S4) a loading operation of the target loading aid with articles based on the loading properties (E1, E2) and the loading parameters P1 . . . P3,
generating a loading pattern,
repeating the aforementioned steps with modified loading parameters (P1 . . . P3),
analyzing (S5) the loading patterns generated on the basis of the target specification, and
selecting (S6) that loading pattern that best fulfils the target specification and generating the loading regulation for the loading device comprising the loading parameters (P1 . . . P3) that lead to the selected loading pattern.

17. The storage and picking system according to claim 16, wherein the storage zone has a plurality of stationary storage racks and at least one automatically operated storage and retrieval device for storing the articles in the storage racks and/or retrieving the articles from the storage racks.

18. The storage and picking system according to claim 16, wherein the source conveying system and/or a target conveying system is configured as a stationary or mobile conveying system.

19. The storage and picking system according to claim 16, wherein:
the source conveying system is configured for horizontal or suspended transport of articles or source loading aids with articles, and/or
the target conveying system is configured for horizontal or suspended transport of the articles or target loading aids with articles.

20. A storage and picking system comprising:
a storage zone for providing articles;
a loading station with an automatic loading device for loading target loading aids with articles according to a loading regulation;
a source conveying system for transporting the articles that connects the storage zone and the loading station;
an order-processing computer for acquiring an order and determining the articles associated with the order;
at least one database, in which loading properties comprising properties of the loading device and/or articles properties of the articles, can be provided; and
a simulation unit, which is connected to a database which is configured to do at least one of:
processing loading properties, comprising properties of the loading device and articles properties of the articles,
processing a loading parameter specification comprising at least one parameter relating to the loading device and/or at least one parameter relating to the articles and/or at least one parameter relating to the target loading aid,
simulating a loading operation of the target loading aid with articles based on the loading properties and the loading parameters,
generating a loading pattern,
repeating the aforementioned steps with modified loading parameters,
analyzing the loading patterns generated on the basis of the target specification, or
selecting that loading pattern that best fulfils the target specification and generating the loading regulation for the loading device comprising the loading parameters that lead to the selected loading pattern.
